(19) United States
(12) Patent Application Publication
(10) Pub. No.: US 2021/0080941 A1
(43) Pub. Date: Mar. 18, 2021

(54) SCALABLE PREDICTIVE MAINTENANCE FOR INDUSTRIAL AUTOMATION EQUIPMENT

(71) Applicant: Rockwell Automation Technologies Inc., Mayfield Heights, OH (US)

(72) Inventors: Rob A. Entzminger, Lenexa, KS (US); Peter A. Morell, Royalton, OH (US); Mithun Mohan Nagabhairava, Waukegan, IL (US); Scotty Bromfield, Johannesburg (ZA)

(21) Appl. No.: 16/573,609

(22) Filed: Sep. 17, 2019

(51) Int. Cl. G05B 23/02; G05B 19/418; G05B 13/02; G06N 20/00

(52) U.S. Cl. CPC G05B 23/0283; G05B 19/41855; G05B 2219/24019; G06N 20/00; G05B 13/026

(57) ABSTRACT

Techniques to facilitate predictive maintenance for industrial assets in an industrial automation environment are disclosed herein. In at least one implementation, a computing system receives a plurality of industrial automation process variables associated with at least one industrial asset employed in an industrial automation process. The industrial automation process variables are fed into a machine learning model associated with the at least one industrial asset to generate a future maintenance event prediction for the at least one industrial asset. The future maintenance event prediction for the at least one industrial asset is provided to an industrial controller that controls the at least one industrial asset.

### TECHNICAL FIELD

Aspects of the disclosure are related to computing hardware and software technology.

### TECHNICAL BACKGROUND

Various manufacturing processes and other industrial operations occur in industrial automation environments. Some examples of industrial automation environments include industrial mining operations, automobile manufacturing factories, food processing plants, oil drilling operations, microprocessor fabrication facilities, and other types of industrial enterprises. Industrial automation environments typically involve many complex systems and processes which are often spread out over various disparate locations. For example, in industrial mining operations, drilling and excavation may occur at several different mining sites to extract ore from the earth, which may then be transported to remote mineral processing plants for further processing to recover desired minerals. Several mechanical and chemical techniques may be employed to aid in the recovery of the target minerals.

Industrial automation environments utilize various machines during the industrial manufacturing process, such as drives, pumps, motors, compressors, valves, robots, and other mechanical devices. These devices have various moving parts and other components that are driven by instructions received from industrial controller systems. Machine builders, solution providers, and other content creators typically produce the control logic needed to run on these industrial controller systems in order to control the mechanical functions of the devices and carry out their intended functions.

Industrial environments also commonly include a human-machine interface (HMI). An HMI typically receives and processes the status data from the machines to generate various graphical displays, which may indicate the current and historical performance of the machines. In traditional implementations, the HMI may also provide a mechanism for an operator to send control instructions to a control system that controls the machines. For example, an operator might use the HMI to direct the control system to update drive parameters, turn on a pump, speed-up a motor, or stop a robot.

### OVERVIEW

Techniques to facilitate predictive maintenance for industrial assets in an industrial automation environment are disclosed herein. In at least one implementation, a computing system receives a plurality of industrial automation process variables associated with at least one industrial asset employed in an industrial automation process. The industrial automation process variables are fed into a machine learning model associated with the at least one industrial asset to generate a future maintenance event prediction for the at least one industrial asset. The future maintenance event prediction for the at least one industrial asset is provided to an industrial controller that controls the at least one industrial asset.

This Overview is provided to introduce a selection of concepts in a simplified form that are further described below in the Detailed Description. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a block diagram that illustrates an industrial automation mining environment in an exemplary implementation.

FIG. 2 is a block diagram that illustrates an operation of a predictive and preventative model in an exemplary implementation.

FIG. 3 is a block diagram that illustrates an exemplary graphical display of a computing system in an exemplary implementation.

FIG. 4 is a flow diagram that illustrates an operation of a computing system in an exemplary implementation.

FIG. 5 is a block diagram that illustrates an operational scenario involving a computing system in an industrial automation environment in an exemplary implementation.

FIG. 6 is a block diagram that illustrates a computing system in an exemplary implementation.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Industrial automation processes commonly utilize machines, electrical devices, and other industrial components to perform various operations, such as motors, drives, bearings, compressors, impellers, valves, sensors, transmitters, and other equipment. These devices have several moving parts and other components that are driven by instructions received from industrial controllers. For example, control logic program code could be processed by an industrial controller in order to update drive parameters, turn on a pump, speed-up a motor, extend a robotic arm, or perform some other action.

However, due to their electromechanical nature, the various components and subsystems employed in industrial automation environments can exhibit changes in operational characteristics and efficacy over time. For example, the performance of valves typically degrades through continuous use, either due to wear, corrosion, restriction, or blockage from abrasive materials. As components progressively wear down and exhibit declines in operational performance, maintenance events may be performed on these components to help restore their operation to initial baseline levels. For example, a failing valve may require maintenance to clear corrosion from the valve, or to shim the valve the restore the valve clearance to within specified tolerances.

The techniques disclosed herein may be utilized to improve predictive maintenance for industrial assets in an industrial automation environment. In at least one implementation, predictive and preventative maintenance models may be enhanced with artificial intelligence, machine learning, and deep learning techniques to generate maintenance event predictions for industrial devices employed in industrial automation processes. For example, by continually receiving and monitoring process variables, predictive and preventative machine learning models may be employed to generate wear rates, failure rates, and maintenance event predictions for industrial assets. In some embodiments, the predictions generated by the models may be provided to an industrial controller to take preventative measures that help to reduce sudden component failures and system downtime and ensure the overall stability of the system.

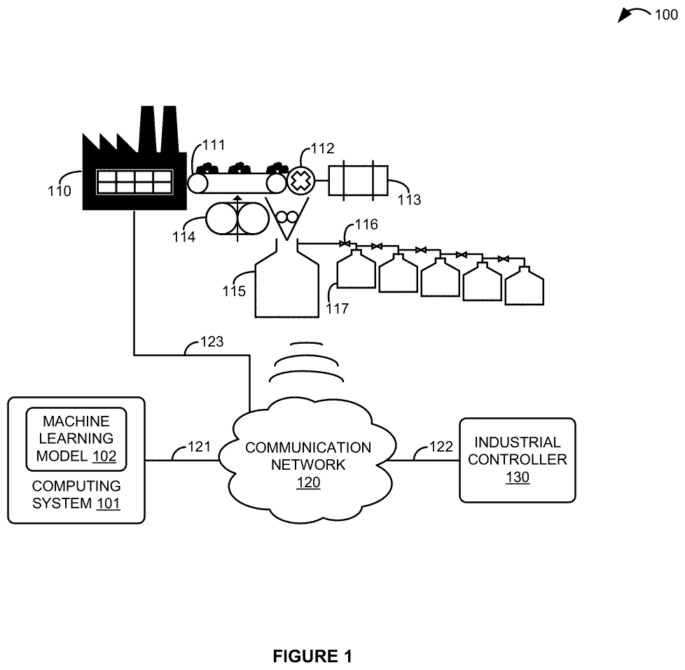

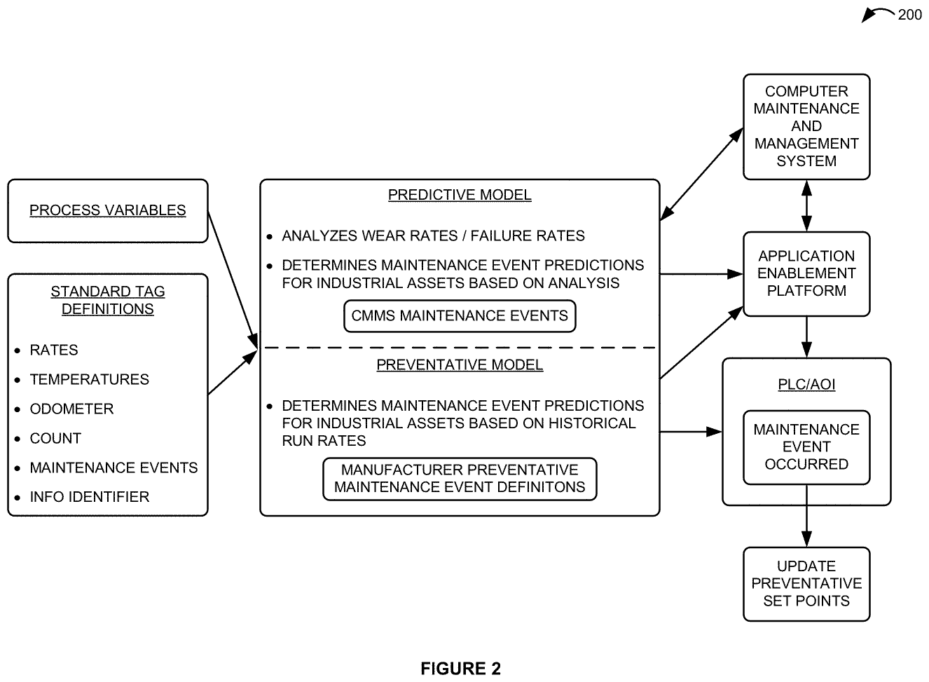

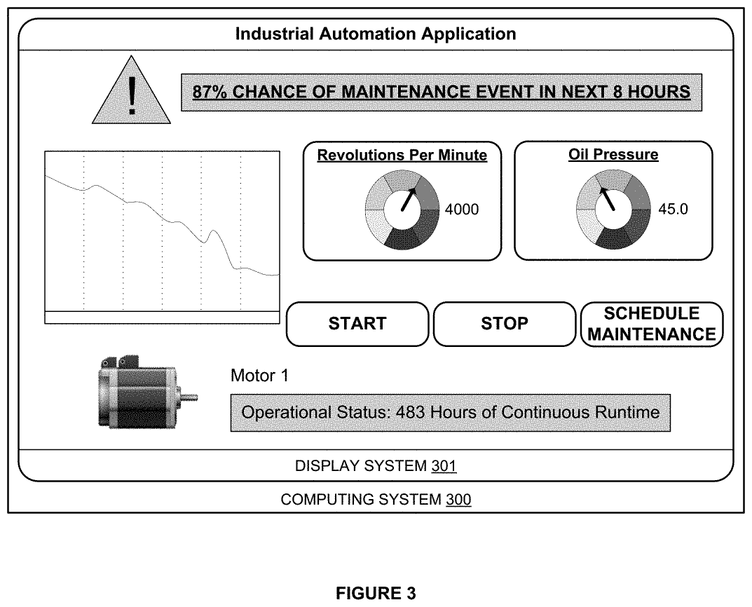

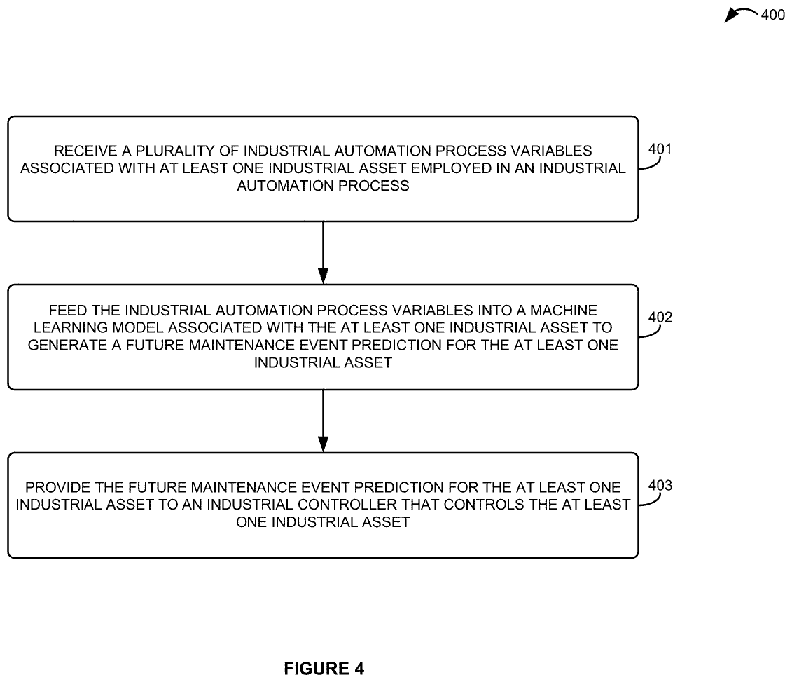

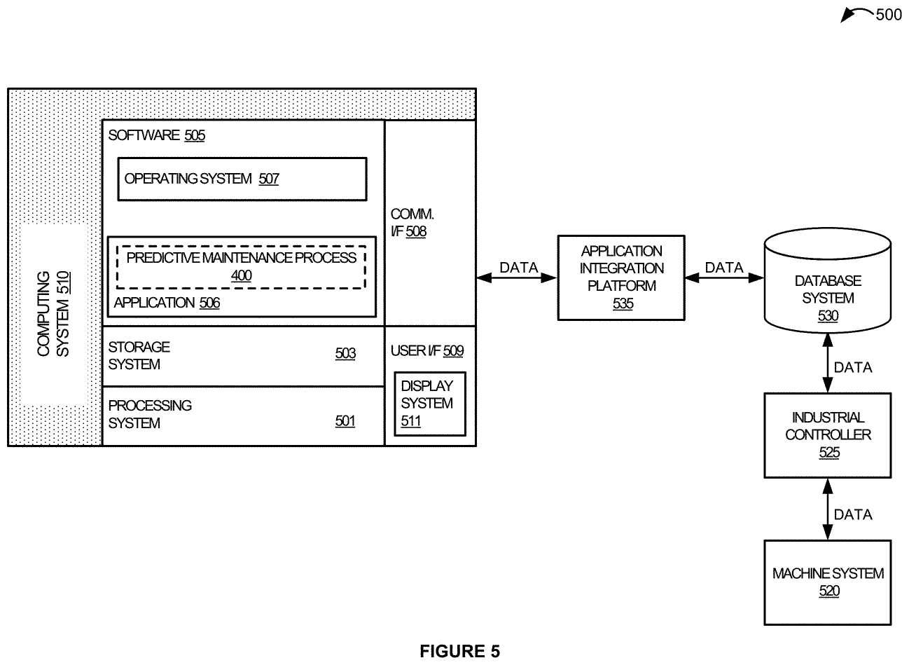

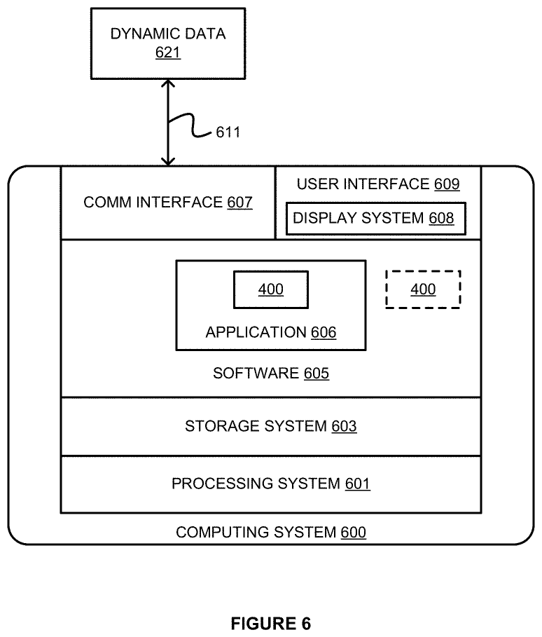

Referring now to the drawings, FIG. 1 illustrates an exemplary industrial automation mining environment that may employ machine learning models to facilitate predictive maintenance for industrial assets. FIG. 2 is a block diagram that illustrates an exemplary operational scenario involving a predictive and preventative model to generate maintenance event predictions. FIG. 3 is a block diagram that illustrates an exemplary graphical display of a computing system in an exemplary implementation. FIG. 4 is a flow diagram that illustrates an operation of a computing system to facilitate predictive maintenance for industrial assets in an industrial automation environment in an exemplary embodiment. FIG. 5 illustrates an exemplary industrial automation environment that includes a computing system that may be used to execute a predictive maintenance process, and FIG. 6 illustrates an exemplary computing system that may be used to perform any of the predictive maintenance processes and operational scenarios described herein.

Turning now to FIG. 1, industrial automation mining environment 100 is illustrated in an exemplary embodiment. Industrial automation mining environment 100 provides an example of an industrial automation environment that may utilize any of the techniques disclosed herein, but note that the present disclosure could equally apply to any other industrial application. In this example, industrial automation mining environment 100 comprises mineral processing facility 110 which is representative of a concentrator plant that employs froth flotation techniques to improve mineral concentrations recovered from extracted ore. Processing facility 110 includes conveyor belt 111, crusher 112, motor 113, compressor 114, surge tank 115, valves 116, and flotation cells 117.

In this example, industrial automation mining environment 100 also includes computing system 101, communication network 120, and industrial controller 130. Computing system 101 includes and executes machine learning model 102. Computing system 101 and communication network 120 communicate over communication link 121, while communication network 120 and industrial controller 130 are in communication over communication link 122. Processing facility 110 is connected to communication network 120 over communication link 123. Any of the industrial assets 111-117 of processing facility 110 may communicate with communication network 120 over communication link 123, which could comprise wired links and/or wireless links, including cellular links, or any other communication links. In some examples, communication network 120 could comprise an on-premise private network or private cloud accessible over a local network connection, a public cloud-based environment accessible over a wide area network such as the Internet, a direct connection such as a bus or serial link, or any other data communication technique, including combinations thereof. The techniques described below with respect to FIG. 1 could be executed by the systems of industrial automation mining environment 100 such as computing system 101 and industrial controller 130, and could be combined with operation 400 of FIG. 4 in some implementations.

In operation, ore is extracted off-site at drilling and excavation sites and delivered to processing facility 110 at a disparate location for flotation cell processing. The extracted ore is transported on conveyor belts 111 and ground into fine particles using crusher 112 operated by motor 113 so that the material is reduced to physically separate grains. This particulate matter is then mixed with water to form a slurry and contained within surge tank 115. The desired mineral is rendered hydrophobic by the addition of a surfactant or collector chemical reagent. The resulting pulp is then introduced to flotation cells 117 by opening valves 116 which is then injected with air or nitrogen from compressor 114 and agitated to form bubbles. The hydrophobic particles containing the desired mineral then attach to the bubbles which rise to the top and collect on the surface as a froth. The froth is then removed from the cell, producing a concentrate of the desired mineral.

In order to carry out the above operations, industrial controller 130 executes control logic code to dispatch control instructions over communication network 120 to control the operation of industrial assets 111-117. Through continuous use, the various components and subsystems employed in flotation cell mineral processing typically degrade over time, and may require maintenance and repairs to restore and sustain desired performance. For example, the performance of crusher 112 typically declines over time due to a wearing down of the rollers and other elements used to grind the mineral ore, which therefore require periodic maintenance and replacement. Accordingly, in this example computing system 101 operates to generate predictive and preventative maintenance determinations for the various subsystems and devices employed in processing facility 110, such as industrial assets 111-117. For example, computing system 101 may receive operational parameters, process variables, performance values, and other information, and then feed this data into machine learning model 102. In at least one implementation, machine learning model 102 then performs a deep analysis on this operational data using artificial intelligence and machine learning techniques in order to determine maintenance event predictions, maintenance interval recommendations, and other preventative maintenance determinations for industrial assets 111-117.

In some implementations, machine learning model 102 may be trained with physical models, empirical performance curves, maintenance event definitions, and other relevant data that describes the operation and performance of industrial assets 111-117 and other components of the system. These performance curves and physical models of the various assets 111-117 are then analyzed by machine learning model 102 along with the process variables, operational parameters, and other values in order to determine the maintenance event predictions for the devices. However, as the components of these devices progressively wear down and their performance curve changes, the physical models used to represent the devices becomes more inaccurate, since they are generally based on initial, fully-operational performance metrics. Therefore, in order to compensate for performance degradation, the physical models representing industrial assets 111-117 and other components may be continually adjusted over time, such as by calculating new offsets or other parameters associated with the models. Further, in at least one example, machine learning model 102 could be employed to calculate the offsets and other values needed to adjust the physical models and performance curves of the components used in the system. For example, through the aggregation and analysis of operational data over extended periods of time, machine learning model 102 could determine how the operational characteristics and performance curve of crusher 112, motor 113, valves 116, and any other components change during the course of their useful lifecycle, and then utilize this information to calculate the offsets and adjustments to the physical models of these components, thereby improving the accuracy of the models. Machine learning model 102 can then utilize these more finely-tuned physical models to better predict when a component may require maintenance or be reaching the end of its useful life, and determine updated set points and other improvements and optimizations for various control settings and operational parameters of industrial assets 111-117 employed in the flotation cell processing example of industrial automation mining environment 100. An exemplary operation of a predictive and optimization machine learning model that may be used to determine maintenance event predictions will now be discussed with respect to FIG. 2.

FIG. 2 is a block diagram that illustrates an operation of a predictive and preventative model in an exemplary implementation 200. The techniques described below with respect to FIG. 2 could be executed by the systems of industrial automation mining environment 100 such as computing system 101 and industrial controller 130, and could be combined with operation 400 of FIG. 4 in some implementations.

In this example, process variables associated with an industrial automation process are fed into a predictive model and a preventative model that utilize machine learning techniques to predict maintenance events for industrial assets. In some implementations, the predictive and preventative models may also utilize a machine learning model to determine improved or optimal process variables, set points, offsets, and other operational settings for the industrial assets, which may be based, at least in part, on the maintenance event predictions. The maintenance event predictions and other determinations generated by the predictive and preventative machine learning models may then be provided to various control systems in order to take action on the predictions and implement various improvements to industrial automation systems.

In operation, process variables associated with an industrial automation process are provided to both the predictive model and the preventative model. Some examples of the process variables could include motor speeds, conveyor belt drive rates, revolutions, pressures, tank levels, agitation rates, air injection rates, flow rates, vibration indicators, valve tolerances, performance curves, and any other operational data. Standard tag definitions may also provided that include rates, temperatures, odometers, counts, maintenance events, information identifiers, and any other defined tag values.

The predictive model comprises a machine learning model trained on the operation of a particular industrial automation process or processes and utilizes physical models of the various devices, components, and subsystems in order to analyze the process variables and make predictions regarding the components employed in the associated industrial automation process. For example, the predictive model can analyze and predict wear rates and failure rates of individual parts and components of various devices that are utilized in an industrial automation process. The predictive model may also analyze the process variables using machine learning techniques to predict maintenance events or determine maintenance intervals for industrial assets and their components, such as valves, motors, drives, bearings, impellers, compressors, sensors, transmitters, and any other components.

In at least one implementation, the maintenance event predictions generated by the predictive model include a likelihood or confidence level of the predicted maintenance event occurring in an upcoming time period. For example, the predictive model could output a determination of a ninety five percent chance of a maintenance event occurring within the next hour, such as a prediction that a motor-driven belt will break within the next hour and halt the production process until the belt is replaced. This prediction confidence level or percent chance of a maintenance event occurring may be used to decide when to schedule preventative maintenance for the identified asset, thereby providing the ability to take proactive steps when necessary to actually prevent a failure from occurring and halting or delaying the industrial process.

In some implementations, the predictive model includes historical data related to computer maintenance and management system (CMMS) maintenance events, which may be utilized by the machine learning aspects of the predictive model to determine future maintenance event predictions. For example, the predictive model could employ machine learning algorithms to analyze historical wear rates and failure rates of any industrial assets and their various components, and determine maintenance event predictions for these assets and components based on the analysis. Further, in at least one implementation, the predictive model may also generate fault detection diagnostics for valves, level transmitters, flow transmitters, pH levels, and any other components or metrics, which can be used for improved fault predictions and preventative maintenance.

Similarly, the preventative model utilizes a machine learning model to determine maintenance event predictions for industrial assets based on historical run rates. For example, the preventative model could employ machine learning algorithms to analyze the historical run rates of any industrial assets and their various components, and determine maintenance event predictions for these assets and components based on the analysis. In at least one implementation, the machine learning model is trained with manufacturer preventative maintenance definitions for respective industrial assets and their components, which are analyzed along with historical and current run rates of the assets to determine maintenance event predictions. For example, a number of counts of a motor being started could be compared with historical start counts and the preventative maintenance definitions provided by the motor manufacturer to determine maintenance event predictions and preventative maintenance recommendations for the motor. Examples of other run rates that could be analyzed by the preventative model include the number of times a cylinder is extended or a solenoid is actuated, or the rate of revolutions of a motor. For example, the preventative model could analyze a motor operating at a particular run rate, and determine using the machine learning component that for running the motor at the current run rate, a certain type of failure or some other maintenance event has occurred in the past, and provide the corresponding maintenance event prediction for the motor.

In at least one implementation, similar to the predictive model, the maintenance event predictions generated by the preventative model could include a likelihood or confidence level of the predicted maintenance event occurring in an upcoming time period. For example, the preventative model could output a determination of a specific percent chance of a maintenance event occurring within a certain time period based on historical run rates, so that preventative maintenance may be scheduled and performed before the maintenance event occurs unexpectedly and stops production. Further, in at least one implementation, the maintenance event predictions generated by both the predictive and preventative models are made independent of the particular industrial asset or component involved. For example, if a maintenance event prediction is made for a machine of a certain type or class, the same predictions and preventative actions should apply to any other machine from that same type or class.

The future maintenance event predictions generated by the predictive and preventative models may be provided to a CMMS and/or an application enablement platform (AEP) in order to take action on the predictions and schedule preventative maintenance events when appropriate to help provide continuous system operation and minimize downtime. In at least one implementation, the predictive and preventative models may utilize an application programming interface (API) to communicate the maintenance event predictions to the CMMS, which could analyze the predictions and responsively take various actions, such as generating work orders, scheduling preventative maintenance and planned downtime, generating alarms and other notification events, conducting asset management tasks such as asset logging and asset planning, and any other actions. Additionally, in some implementations the CMMS may interact with the AEP in order to achieve some or all of this functionality. For example, events may occur that could cause the CMMS to contact the AEP to transfer control instructions such as an add-on instruction (AOI), user-defined data type (UDT) instruction, or some other logic program code to the programmable logic controller (PLC), which would process the control instructions and perform the corresponding functions. In this manner, output from the predictive and preventative models related to individual components that are utilized in an industrial automation process, such as upcoming maintenance events, recommended maintenance intervals, and other predictions may be communicated to the CMMS and/or the AEP and which can responsively instruct the PLC to take appropriate action.

Moreover, in some implementations, the maintenance event predictions, recommended maintenance intervals, and other determinations by the predictive and preventative models could be provided directly to the PLC, enabling the PLC to consider the predictions and take preventative action accordingly. For example, the PLC could process the maintenance event predictions with control instructions such as AOI or UDT instructions or some other logic program code to automatically make decisions as to whether or not to perform or schedule maintenance for the industrial assets identified in the maintenance event predictions. Responsive to the output from the predictive and preventative models, the PLC may also be configured to update the process variables and settings, parameters, set points, proportional integral derivative (PID) offsets, and other control values associated with an industrial automation process. For example, in at least one implementation, the PLC may be configured to update preventative set points in the PLC responsive to a maintenance event actually occurring for a particular industrial asset. For example, the PLC may reset a start counter for a motor after maintenance is performed on the motor in order to update a preventative set point in the PLC for the motor.

In addition to maintenance predictions, in at least one implementation the machine learning models are capable of analyzing the process variables and determining improvements and optimizations for the associated components. For example, the machine learning models could analyze empirical performance curves and the physical models representing the various components of the industrial automation process to determine more efficient and optimal settings for the process variables. In some examples, the process improvements and optimizations determined by the models could include energy improvements that minimize the amount of energy used by each component or process, improvements for the timing and synchronization of the system and various subsystems, improvements to reduce the amount of materials and other resources that are used and to increase the amount of process output or production, and improvements for the overall process throughput. The machine learning models may also dynamically create updated set point improvements and optimizations in real time, and can determine these and other improvements for both individual components and the overall system. The updated set points determined by the machine learning models may be provided to the PLC, which can then execute code to take action and make changes to update the set points for the various components as directed by the models.

Further, in at least one implementation, the PLC may provide a desired system output to the machine learning models, which may then be used as a basis for determining improvements to settings for process variables, updated set points, PID offsets, and any other system optimizations. For example, the PLC could operate in a closed-loop with the models, where empirical performance curves may be provided from the models to the PLC in the form of AOI or UDT instructions, and the desired or ideal system output is provided back to the models by the PLC. This bidirectional communication that may exist between the PLC and the models enables dynamic updates to component performance curve models, allowing for the machine learning aspects of the predictive and preventative models to make adjustments to the performance curves empirically and compensate for changes or declines in performance of various components over time. These adjustments to the performance curves and corresponding updates to the physical models of various industrial assets enables the machine learning models to be dynamically retrained over time to allow for new or changed behavior of the assets to be accounted for in the predictive analysis and preventative action recommendations. Additionally, the continual adjustments to the models to compensate for changes in performance of the various industrial assets over time may allow for the confidence level in the maintenance event predictions generated by the predictive and preventative models to be increased, since these determinations would be based on more accurate representations of the underlying assets. In some implementations, the maintenance event predictions may be presented along with their associated confidence levels to better enable a user to make a decision as to whether or not to take preventative action. An exemplary graphical display that may be presented to a user on a computing system that indicates a maintenance event prediction will now be discussed with respect to FIG. 3.

FIG. 3 is a block diagram that illustrates an exemplary graphical display of computing system 300 in an exemplary implementation. Computing system 300 provides an example of computing system 101 of FIG. 1, although computing system 101 could use alternative configurations. In this example, computing system 300 includes display system 301 which provides a graphical user interface for an industrial automation application, which could comprise human-machine interface (HMI) software in some implementations. The techniques described below with respect to FIG. 3 could be executed by the systems of industrial automation mining environment 100 such as computing system 101 and industrial controller 130, and could be combined with operation 400 of FIG. 4 in some implementations.

As presented on display system 301, the graphical display provides information and operational status metrics related to a motor employed in an industrial automation process. In this example, the display provides a graphical representation of a performance curve for the motor, along with two gauges that indicate the current operating conditions of the motor with respect to revolutions per minute and oil pressure. The graphical display also provides control buttons that enable a user to start and stop the motor or schedule maintenance. Below these command buttons, an informational text box provides an operational status of the motor that indicates the number of hours of continuous runtime.

At the top of the graphical display, a warning alert indicator represented by an exclamation point within a triangle is displayed. An alert text box appearing to the right of the warning alert indicator displays a warning status that indicates an eighty seven percent chance of a maintenance event occurring for the motor in the next eight hours. In at least one implementation, this warning status message may be provided by a machine learning model that generates the maintenance event prediction for the motor along with the associated confidence percentage of the maintenance event occurring within the specified time period. By presenting the maintenance event prediction as a warning alert on the graphical display of the industrial automation application, a user can be immediately notified of the upcoming maintenance event prediction and take appropriate preventative action to avoid a failure of the motor and any unplanned system downtime. An exemplary operation to facilitate predictive maintenance for industrial assets in an industrial automation environment will now be described in greater detail with respect to FIG. 4.

FIG. 4 is a flow diagram that illustrates an operation 400 of a computing system in an exemplary implementation. The operation 400 shown in FIG. 4 may also be referred to as predictive maintenance process 400 herein. The steps of the operation are indicated below parenthetically. The following discussion of operation 400 will proceed with reference to computing system 101, machine learning model 102, and industrial controller 130 of FIG. 1 in order to illustrate its operations, but note that the details provided in FIG. 1 are merely exemplary and not intended to limit the scope of process 400 to the specific implementation shown in FIG. 1.

Operation 400 may be employed to operate computing system 101 to facilitate predictive maintenance for industrial assets in an industrial automation environment. As shown in the operational flow of process 400, computing system 101 receives a plurality of industrial automation process variables associated with at least one industrial asset employed in an industrial automation process (401). In some examples, the industrial automation process variables could comprise any operational settings, performance metrics, sensor data, empirical curves, set points, PID values, offsets, or any other operational data associated with an industrial automation process. In at least one implementation, the industrial automation process variables could comprise motor speeds, conveyor belt drive rates, revolutions, pressures, tank levels, agitation rates, air injection rates, flow rates, vibration indicators, valve tolerances, performance curves, and any other operational data. In some implementations, the industrial automation process variables could include standard tag definitions that may include rates, temperatures, odometers, counts, maintenance events, information identifiers, and any other defined tag values. Any other industrial automation process data could be included in the industrial automation process variables received by computing system 101 and is within the scope of this disclosure.

Computing system 101 feeds the industrial automation process variables into machine learning model 102 associated with the at least one industrial asset to generate a future maintenance event prediction for the at least one industrial asset (402). In at least one implementation, machine learning model 102 analyzes the industrial automation process variables to determine the future maintenance event prediction for the at least one industrial asset employed in the industrial automation process. In some examples, computing system 101 could provide the process variables to machine learning model 102 to determine future maintenance event predictions for individual components employed in the industrial automation process and for any other maintenance predictions associated with the industrial automation process. In at least one implementation, machine learning model 102 is trained on the operation of the industrial automation process along with physical models of various components employed in the process in order to analyze the process variables and determine the future maintenance event prediction for the components associated with the process variables. For example, machine learning model 102 could process and analyze the physical models and empirical curves representing the operational characteristics of various components to determine future maintenance event predictions for one or more industrial assets associated with the process variables.

In some implementations, the future maintenance event prediction for the at least one industrial asset employed in the industrial automation process could include an updated set point associated with the industrial automation process. For example, in at least one implementation, machine learning model 102 could dynamically create updated set points in real time in response to a predicted maintenance event or to achieve a desired system output, and can determine these set points and other updated settings for both individual components and the overall system. The desired system output may be provided to machine learning model 102 by industrial controller 130 in some examples. Further, in some implementations, the future maintenance event prediction for the industrial automation process could include an updated offset to a proportional, integral, and derivative (PID) control associated with the industrial automation process. For example, if a maintenance event is predicted for a particular industrial asset due to a decline in performance of the asset that causes the process stability to drop below threshold tolerance levels, a change to the PID control for that asset could be determined dynamically by machine learning model 102 and updated in real time to compensate for the decline in performance, improve the process stability, and potentially delay the immediate need to take preventative action with respect to the maintenance event prediction of the industrial asset. Moreover, in some implementations, there could be several PID controls for each industrial asset and component employed in the industrial automation process, and machine learning model 102 could determine improved settings for any or all of these PID controls to adjust for future maintenance event predictions and provide adaptive control of the industrial automation process.

In some examples, machine learning model 102 could also be adjusted dynamically to compensate for changes in performance over time. For example, because of their mechanical nature, the various components and subsystems employed in an industrial automation process can exhibit continual changes in operational characteristics and efficacy throughout their lifetime. As components progressively wear down and their performance curve changes, the physical models and performance curves used to represent the components in machine learning model 102 becomes more inaccurate. Therefore, in order to compensate for performance degradation, the physical models representing various components may be continually adjusted over time, such as by calculating new offsets or other parameters associated with the models. In some examples, machine learning model 102 could be employed to calculate the offsets and other values needed to adjust the physical models in machine learning model 102 that represent the various components used in the industrial automation process. For example, in at least one implementation, computing system 101 could provide updated process variables to machine learning model 102 that indicate a change in performance associated with at least one industrial asset or any other aspect of the industrial automation process, and machine learning model 102 could be configured to automatically adjust machine learning model 102 to compensate for the change in performance. In this example, the change in performance associated with the at least one industrial asset could comprise any variation in operational characteristics or deviation in the performance curve model of the industrial assets or components used in the industrial automation process that may be analyzed to determine adjustments for machine learning model 102 to compensate for the change in performance. In some implementations, machine learning model 102 could include a dynamic model established for each industrial asset or other components used in the industrial automation process, which may be continually updated by utilizing the self-learning capabilities of machine learning model 102 in order to provide adaptive control that adjusts for performance degradation of various components.

Additionally, in at least one implementation, the future maintenance event prediction could comprise a confidence level associated with the future maintenance event prediction. For example, machine learning model 102 could determine a percentage level of confidence in the future maintenance event prediction based on a variety of factors associated with the process variables and other information used to generate the future maintenance event prediction, and could indicate the confidence level along with the future maintenance event prediction in some implementations. Further, in at least one implementation, the future maintenance event prediction could indicate a likelihood of a maintenance event associated with the at least one industrial asset occurring within an upcoming time period. For example, the predictive model could output a determination of an eighty five percent chance of a maintenance event occurring within the next two hours. This prediction confidence level or percent chance of a maintenance event occurring may be used to decide when to schedule preventative maintenance for the identified asset, thereby providing the ability to take preventative actions when necessary to avoid component failures and undesirable system downtime.

Computing system 101 provides the future maintenance event prediction for the at least one industrial asset to industrial controller 130 that controls the at least one industrial asset (403). For example, in at least one implementation, industrial controller 130 could comprise a programmable logic controller (PLC) that controls valves, motors, drives, compressors, levels, rates, and any other aspects of the industrial automation process. In at least one implementation, the future maintenance event prediction determined by machine learning model 102 may be provided by computing system 101 to industrial controller 130, which can then execute logic code to take preventative action for the future maintenance event prediction, such as schedule maintenance, swap in a different industrial asset to remove the asset associated with the predicted maintenance event from the process operation, apply updated settings for the industrial asset or any other components associated with the industrial automation process, or perform any other actions. In some implementations, industrial controller 130 could be configured to process the future maintenance event prediction to determine whether or not to take a preventative action, schedule a maintenance event, update a preventative set point, or perform any other functions based on the future maintenance event prediction and/or the confidence level or likelihood of a maintenance event associated with the at least one industrial asset occurring within an upcoming time period. In some examples, when the future maintenance event prediction includes updated set points or PID control values, industrial controller 130 could be configured to implement and apply the updated set points, PID control values, and any other improved settings for the industrial automation process. Further, in at least one implementation, industrial controller 130 may be configured to update at least one preventative set point associated with the at least one industrial asset responsive to a maintenance event occurring for the at least one industrial asset. Other operations of computing system 101, machine learning model 102, and industrial controller 130 with respect to maintenance events and future maintenance event predictions are possible and within the scope of this disclosure.

Advantageously, computing system 101 utilizes machine learning model 102 to determine a future maintenance event prediction for at least one industrial asset employed in an industrial automation process. By collecting and analyzing industrial automation process variables with machine learning model 102, computing system 101 may continuously determine wear and failure rates, maintenance event predictions, maintenance interval recommendations, and other determinations for industrial assets and other components employed in the industrial automation process. In this manner, predictive maintenance for industrial assets in an industrial automation environment can be scheduled and performed, thereby allowing for industrial automation processing to be improved for better operational efficiency and increased process output or production rates of the industrial automation process.

Now referring back to FIG. 1, computing system 101 comprises a processing system and communication transceiver. Computing system 101 may also include other components such as a user interface, data storage system, and power supply. Computing system 101 may reside in a single device or may be distributed across multiple devices. Examples of computing system 101 include mobile computing devices, such as cell phones, tablet computers, laptop computers, notebook computers, and gaming devices, as well as any other type of mobile computing devices and any combination or variation thereof. Examples of computing system 101 also include desktop computers, server computers, and virtual machines, as well as any other type of computing system, variation, or combination thereof. In some implementations, computing system 101 could comprise a mobile device capable of operating in a server-like fashion which, among other uses, could be utilized in a wireless mesh network.

Communication network 120 could comprise multiple network elements such as routers, gateways, telecommunication switches, servers, processing systems, or other communication equipment and systems for providing communication and data services. In some examples, communication network 120 could comprise wireless communication nodes, telephony switches, Internet routers, network gateways, computer systems, communication links, or some other type of communication equipment, including combinations thereof. Communication network 120 may also comprise optical networks, packet networks, cellular networks, wireless mesh networks (WMN), local area networks (LAN), metropolitan area networks (MAN), wide area networks (WAN), or other network topologies, equipment, or systems, including combinations thereof. Communication network 120 may be configured to communicate over metallic, wireless, or optical links. Communication network 120 may be configured to use time-division multiplexing (TDM), Internet Protocol (IP), Ethernet, optical networking, wireless protocols, communication signaling, peer-to-peer networking over Bluetooth, Bluetooth low energy, Wi-Fi Direct, near field communication (NFC), or some other communication format, including combinations thereof. In some examples, communication network 120 includes further access nodes and associated equipment for providing communication services to several computer systems across a large geographic region.

Industrial controller 130 generally comprises a processing system and communication transceiver. Industrial controller 130 may reside in a single device or may be distributed across multiple devices. Industrial controller 130 may be a discrete system or may be integrated within other systems, including other systems within industrial automation environment 100 or an automation control system. In some examples, industrial controller 130 could comprise automation controllers, programmable logic controllers (PLCs), programmable automation controllers (PACs), or any other controllers used in automation control. In some implementations, a PLC, PAC, and/or specific modules within a PLC rack could provide some or all of the functionality described herein for industrial controller 130. In some examples, industrial controller 130 could comprise a ControlLogix® control system provided by Rockwell Automation, Inc.

Communication links 121, 122, and 123 use metal, air, space, optical fiber such as glass or plastic, or some other material as the transport medium, including combinations thereof. Communication links 121, 122, and 123 could use various communication protocols, such as TDM, IP, Ethernet, telephony, cellular, optical networking, hybrid fiber coax (HFC), communication signaling, wireless protocols, or some other communication format, including combinations thereof. Communication links 121, 122, and 123 could be direct links or may include intermediate networks, systems, or devices.

Turning now to FIG. 5, a block diagram that illustrates an industrial automation environment 500 in an exemplary implementation is shown. Industrial automation environment 500 provides an example of an industrial automation environment that may be utilized to implement the predictive maintenance processes disclosed herein, but other environments could also be used. Industrial automation environment 500 includes computing system 510, machine system 520, industrial controller 525, database system 530, and application integration platform 535. Computing system 510 provides an example of computing systems 101 and 300, although systems 101 and 300 could use alternative configurations. Industrial controller 525 provides an example of industrial controller 130, although controller 130 could use alterative configurations. Machine system 520 and controller 525 are in communication over a communication link, controller 525 and database system 530 communicate over a communication link, database system 530 and application integration platform 535 communicate over a communication link, and application integration platform 535 and computing system 510 are in communication over a communication link. Note that there would typically be many more machine systems in most industrial automation environments, but the number of machine systems shown in FIG. 5 has been restricted for clarity.

Industrial automation environment 500 comprises an industrial mining operation, automobile manufacturing factory, food processing plant, oil drilling operation, microprocessor fabrication facility, or some other type of industrial enterprise. Machine system 520 could comprise a sensor, drive, pump, filter, drill, motor, robot, fabrication machinery, mill, printer, or any other industrial automation equipment, including their associated control systems. A control system comprises, for example, industrial controller 525, which could include automation controllers, programmable logic controllers (PLCs), programmable automation controllers (PACs), or any other controllers used in automation control. Additionally, machine system 520 could comprise other industrial equipment, such as a brew kettle in a brewery, a reserve of coal or other resources, or any other element that may reside in an industrial automation environment 500.

Machine system 520 continually produces operational data over time. The operational data indicates the current status of machine system 520, such as parameters, pressure, temperature, speed, energy usage, operational equipment effectiveness (OEE), mean time between failure (MTBF), mean time to repair (MTTR), voltage, throughput volumes, times, tank levels, or any other performance status metrics. The operational data may comprise dynamic charts or trends, real-time video, or some other graphical content. Machine system 520 and/or controller 525 is capable of transferring the operational data over a communication link to database system 530, application integration platform 535, and computing system 510, typically via a communication network. Database system 530 could comprise a disk, tape, integrated circuit, server, or some other memory device. Database system 530 may reside in a single device or may be distributed among multiple memory devices.

Application integration platform 535 comprises a processing system and a communication transceiver. Application integration platform 535 may also include other components such as a router, server, data storage system, and power supply. Application integration platform 535 may reside in a single device or may be distributed across multiple devices. Application integration platform 535 may be a discrete system or may be integrated within other systems, including other systems within industrial automation environment 500. In some examples, application integration platform 535 could comprise a FactoryTalk® VantagePoint server system provided by Rockwell Automation, Inc.

The communication links over which data is exchanged between machine system 520, industrial controller 525, database system 530, application integration platform 535, and communication interface 508 of computing system 510 could use metal, air, space, optical fiber such as glass or plastic, or some other material as the transport medium, including combinations thereof. The communication links could comprise multiple network elements such as routers, gateways, telecommunication switches, servers, processing systems, or other communication equipment and systems for providing communication and data services. These communication links could use various communication protocols, such as TDM, IP, Ethernet, telephony, optical networking, packet networks, cellular networks, wireless mesh networks (WMN), local area networks (LAN), metropolitan area networks (MAN), wide area networks (WAN), hybrid fiber coax (HFC), communication signaling, wireless protocols, communication signaling, peer-to-peer networking over Bluetooth, Bluetooth low energy, Wi-Fi Direct, near field communication (NFC), or some other communication format, including combinations thereof. The communication links could be direct links or may include intermediate networks, systems, or devices.

Computing system 510 may be representative of any computing apparatus, system, or systems on which the predictive maintenance processes disclosed herein or variations thereof may be suitably implemented. Computing system 510 provides an example of a computing system that could be used as a either a server or a client device in some implementations, although such devices could have alternative configurations. Examples of computing system 510 include mobile computing devices, such as cell phones, tablet computers, laptop computers, notebook computers, and gaming devices, as well as any other type of mobile computing devices and any combination or variation thereof. Examples of computing system 510 also include desktop computers, server computers, and virtual machines, as well as any other type of computing system, variation, or combination thereof. In some implementations, computing system 510 could comprise a mobile device capable of operating in a server-like fashion which, among other uses, could be utilized in a wireless mesh network.

Computing system 510 includes processing system 501, storage system 503, software 505, communication interface 508, and user interface 509. Processing system 501 is operatively coupled with storage system 503, communication interface 508, and user interface 509. Processing system 501 loads and executes software 505 from storage system 503. Software 505 includes application 506 and operating system 507. Application 506 may include predictive maintenance process 400 in some examples. When executed by computing system 510 in general, and processing system 501 in particular, software 505 directs computing system 510 to operate as described herein for predictive maintenance process 400 or variations thereof. In this example, user interface 509 includes display system 511, which itself may be part of a touch screen that also accepts user inputs via touches on its surface. Computing system 510 may optionally include additional devices, features, or functionality not discussed here for purposes of brevity.

Turning now to FIG. 6, a block diagram is shown that illustrates computing system 600 in an exemplary implementation. Computing system 600 provides an example of computing system 101 or any computing system that may be used to execute predictive maintenance process 400 or variations thereof, although computing system 101 could use alternative configurations. Computing system 600 includes processing system 601, storage system 603, software 605, communication interface 607, and user interface 609. User interface 609 comprises display system 608. Software 605 includes application 606 which itself includes predictive maintenance process 400. Predictive maintenance process 400 may optionally be implemented separately from application 606, as indicated by the dashed line in FIG. 6.

Computing system 600 may be representative of any computing apparatus, system, or systems on which application 606 and predictive maintenance process 400 or variations thereof may be suitably implemented. Examples of computing system 600 include mobile computing devices, such as cell phones, tablet computers, laptop computers, notebook computers, and gaming devices, as well as any other type of mobile computing devices and any combination or variation thereof. Note that the features and functionality of computing system 600 may apply as well to desktop computers, server computers, and virtual machines, as well as any other type of computing system, variation, or combination thereof.

Computing system 600 includes processing system 601, storage system 603, software 605, communication interface 607, and user interface 609. Processing system 601 is operatively coupled with storage system 603, communication interface 607, and user interface 609. Processing system 601 loads and executes software 605 from storage system 603. When executed by computing system 600 in general, and processing system 601 in particular, software 605 directs computing system 600 to operate as described herein for predictive maintenance process 400 or variations thereof. Computing system 600 may optionally include additional devices, features, or functionality not discussed herein for purposes of brevity.

Referring still to FIG. 6, processing system 601 may comprise a microprocessor and other circuitry that retrieves and executes software 605 from storage system 603. Processing system 601 may be implemented within a single processing device but may also be distributed across multiple processing devices or sub-systems that cooperate in executing program instructions. Examples of processing system 601 include general purpose central processing units, application specific processors, and logic devices, as well as any other type of processing device, combinations, or variations thereof.

Storage system 603 may comprise any computer-readable storage media capable of storing software 605 and readable by processing system 601. Storage system 603 may include volatile and nonvolatile, removable and non-removable media implemented in any method or technology for storage of information, such as computer readable instructions, data structures, program modules, or other data. Storage system 603 may be implemented as a single storage device but may also be implemented across multiple storage devices or sub-systems co-located or distributed relative to each other. Storage system 603 may comprise additional elements, such as a controller, capable of communicating with processing system 601. Examples of storage media include random-access memory, read-only memory, magnetic disks, optical disks, flash memory, virtual memory and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In no case is the computer-readable storage media a propagated signal.

In operation, in conjunction with user interface 609, processing system 601 may load and execute portions of software 605, such as predictive maintenance process 400, to render a graphical user interface for application 606 for display by display system 608 of user interface 609. Software 605 may be implemented in program instructions and among other functions may, when executed by computing system 600 in general or processing system 601 in particular, direct computing system 600 or processing system 601 to receive a plurality of industrial automation process variables associated with at least one industrial asset employed in an industrial automation process. Software 605 may further direct computing system 600 or processing system 601 to feed the industrial automation process variables into a machine learning model associated with the at least one industrial asset to generate a future maintenance event prediction for the at least one industrial asset. In addition, software 605 directs computing system 600 or processing system 601 to provide the future maintenance event prediction for the at least one industrial asset to an industrial controller that controls the at least one industrial asset.

Software 605 may include additional processes, programs, or components, such as operating system software or other application software. Examples of operating systems include Windows®, iOS®, and Android®, as well as any other suitable operating system. Software 605 may also comprise firmware or some other form of machine-readable processing instructions executable by processing system 601.

In general, software 605 may, when loaded into processing system 601 and executed, transform computing system 600 overall from a general-purpose computing system into a special-purpose computing system customized to facilitate predictive maintenance for industrial assets in an industrial automation environment as described herein for each implementation. For example, encoding software 605 on storage system 603 may transform the physical structure of storage system 603. The specific transformation of the physical structure may depend on various factors in different implementations of this description. Examples of such factors may include, but are not limited to the technology used to implement the storage media of storage system 603 and whether the computer-storage media are characterized as primary or secondary storage.

In some examples, if the computer-storage media are implemented as semiconductor-based memory, software 605 may transform the physical state of the semiconductor memory when the program is encoded therein. For example, software 605 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 600 is generally intended to represent a computing system with which software 605 is deployed and executed in order to implement application 606 and/or predictive maintenance process 400 (and variations thereof). However, computing system 600 may also represent any computing system on which software 605 may be staged and from where software 605 may be distributed, transported, downloaded, or otherwise provided to yet another computing system for deployment and execution, or yet additional distribution. For example, computing system 600 could be configured to deploy software 605 over the internet to one or more client computing systems for execution thereon, such as in a cloud-based deployment scenario.

Communication interface 607 may include communication connections and devices that allow for communication between computing system 600 and other computing systems (not shown) or services, over a communication network 611 or collection of networks. In some implementations, communication interface 607 receives dynamic data 621 over communication network 611. Examples of connections and devices that together allow for inter-system communication may include network interface cards, antennas, power amplifiers, RF circuitry, transceivers, and other communication circuitry. The aforementioned network, connections, and devices are well known and need not be discussed at length here.

User interface 609 may include a voice input device, a touch input device for receiving a gesture from a user, a motion input device for detecting non-touch gestures and other motions by a user, and other comparable input devices and associated processing elements capable of receiving user input from a user. Output devices such as display system 608, speakers, haptic devices, and other types of output devices may also be included in user interface 609. The aforementioned user input devices are well known in the art and need not be discussed at length here. User interface 609 may also include associated user interface software executable by processing system 601 in support of the various user input and output devices discussed above. Separately or in conjunction with each other and other hardware and software elements, the user interface software and devices may provide a graphical user interface, a natural user interface, or any other kind of user interface. User interface 609 may be omitted in some examples.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The above description and associated drawings teach the best mode of the invention. The following claims specify the scope of the invention. Some aspects of the best mode may not fall within the scope of the invention as specified by the claims. Also, while the preceding discussion describes embodiments employed specifically in conjunction with the monitoring and analysis of industrial processes, other applications, such as the mathematical modeling or monitoring of any man-made or naturally-existing system, may benefit from use of the concepts discussed above. Further, those skilled in the art will appreciate that the features described above can be combined in various ways to form multiple variations of the invention. As a result, the invention is not limited to the specific embodiments described above, but only by the following claims and their equivalents.

What is claimed is:

1. One or more computer-readable storage media having program instructions stored thereon to facilitate predictive maintenance for industrial assets in an industrial automation environment, wherein the program instructions, when executed by a computing system, direct the computing system to at least:
receive a plurality of industrial automation process variables associated with at least one industrial asset employed in an industrial automation process;
feed the industrial automation process variables into a machine learning model associated with the at least one industrial asset to generate a future maintenance event prediction for the at least one industrial asset; and
provide the future maintenance event prediction for the at least one industrial asset to an industrial controller that controls the at least one industrial asset.

2. The one or more computer-readable storage media of claim 1 wherein the industrial controller is configured to process the future maintenance event prediction to determine whether or not to take a preventative action based on the future maintenance event prediction.

3. The one or more computer-readable storage media of claim 1 wherein the industrial controller is configured to process the future maintenance event prediction to determine whether or not to schedule a maintenance event for the at least one industrial asset based on the future maintenance event prediction.

4. The one or more computer-readable storage media of claim 1 wherein the program instructions direct the computing system to provide updated process variables to the machine learning model that indicate a change in performance associated with the at least one industrial asset, and wherein the machine learning model is configured to automatically adjust the machine learning model to compensate for the change in performance.

5. The one or more computer-readable storage media of claim 1 wherein the future maintenance event prediction comprises a confidence level associated with the future maintenance event prediction.

6. The one or more computer-readable storage media of claim 1 wherein the future maintenance event prediction indicates a likelihood of a maintenance event associated with the at least one industrial asset occurring within an upcoming time period.

7. The one or more computer-readable storage media of claim 1 wherein the industrial controller is configured to update at least one preventative set point associated with the at least one industrial asset responsive to a maintenance event occurring for the at least one industrial asset.

8. A method to facilitate predictive maintenance for industrial assets in an industrial automation environment, the method comprising:
receiving a plurality of industrial automation process variables associated with at least one industrial asset employed in an industrial automation process;
feeding the industrial automation process variables into a machine learning model associated with the at least one industrial asset to generate a future maintenance event prediction for the at least one industrial asset; and
providing the future maintenance event prediction for the at least one industrial asset to an industrial controller that controls the at least one industrial asset.

9. The method of claim 8 wherein the industrial controller is configured to process the future maintenance event prediction to determine whether or not to take a preventative action based on the future maintenance event prediction.

10. The method of claim 8 wherein the industrial controller is configured to process the future maintenance event prediction to determine whether or not to schedule a maintenance event for the at least one industrial asset based on the future maintenance event prediction.

11. The method of claim 8 further comprising providing updated process variables to the machine learning model that indicate a change in performance associated with the at least one industrial asset, and wherein the machine learning model is configured to automatically adjust the machine learning model to compensate for the change in performance.

12. The method of claim 8 wherein the future maintenance event prediction comprises a confidence level associated with the future maintenance event prediction.

13. The method of claim 8 wherein the future maintenance event prediction indicates a likelihood of a maintenance event associated with the at least one industrial asset occurring within an upcoming time period.

14. The method of claim 8 wherein the industrial controller is configured to update at least one preventative set point associated with the at least one industrial asset responsive to a maintenance event occurring for the at least one industrial asset.

15. An apparatus to facilitate predictive maintenance for industrial assets in an industrial automation environment, the apparatus comprising:
one or more computer-readable storage media; and
program instructions stored on the one or more computer-readable storage media that, when executed by a processing system, direct the processing system to at least:
receive a plurality of industrial automation process variables associated with at least one industrial asset employed in an industrial automation process;
feed the industrial automation process variables into a machine learning model associated with the at least one industrial asset to generate a future maintenance event prediction for the at least one industrial asset; and
provide the future maintenance event prediction for the at least one industrial asset to an industrial controller that controls the at least one industrial asset.

16. The apparatus of claim 15 wherein the industrial controller is configured to process the future maintenance event prediction to determine whether or not to take a preventative action based on the future maintenance event prediction.

17. The apparatus of claim 15 wherein the industrial controller is configured to process the future maintenance event prediction to determine whether or not to schedule a maintenance event for the at least one industrial asset based on the future maintenance event prediction.

18. The apparatus of claim 15 wherein the program instructions direct the processing system to provide updated process variables to the machine learning model that indicate a change in performance associated with the at least one industrial asset, and wherein the machine learning model is configured to automatically adjust the machine learning model to compensate for the change in performance.

19. The apparatus of claim 15 wherein the future maintenance event prediction comprises a confidence level associated with the future maintenance event prediction.

20. The apparatus of claim 15 wherein the future maintenance event prediction indicates a likelihood of a maintenance event associated with the at least one industrial asset occurring within an upcoming time period.
